(19) United States
(12) Patent Application Publication
(10) Pub. No.: US 2024/0384133 A1
(43) Pub. Date: Nov. 21, 2024

(54) FOAMABLE POWDER-BASED COMPOSITION AND THE FOAMING METHOD THEREOF

(71) Applicant: Henkel AG & Co. KGaA, Düsseldorf (DE)

(72) Inventors: Yipeng Wei, Shanghai (CN); Jianlin Qiu, Shanghai (CN); Yanli Huo, Shanghai (CN)

(21) Appl. No.: 18/785,209

(22) Filed: Jul. 26, 2024

Related U.S. Application Data
(63) Continuation of application No. PCT/CN2022/074898, filed on Jan. 29, 2022.

(51) Int. Cl. C09J 5/08; C09J 5/06; C09J 11/04; C09J 11/08; C09J 131/04; C09J 133/20

(52) U.S. Cl. CPC C09J 5/08; C09J 5/06; C09J 11/04; C09J 11/08; C09J 131/04; C09J 133/20

(57) ABSTRACT

Described herein is a foamable powder-based composition, comprising: (a) at least one powder-based polymer in an amount of no less than 8% by weight, based on the total weight of the composition, (b) at least one plurality of expandable microspheres in an amount of no less than 15% by weight, based on the total weight of the composition, and (c) optionally at least one filler, wherein the plurality of expandable microspheres in the composition expands when heating; and wherein the composition has a water content of no more than 3% by weight based on the total weight of the composition.

### TECHNICAL FIELD

The present invention relates to a foamable powder-based composition and the foaming method thereof. In particular, the present invention relates to a foamable powder-based composition which is able to withstand prolonged storage and shipment in high temperature as well as the foaming method thereof.

### BACKGROUND

A more environmentally sound disposable food packages and containers are sought after than traditional closed-cell extruded polystyrene foam packages. Packages made entirely out of plastic typically do not biodegrade in less than 400 years, or if ever, and some regulations have banned the use of such packages and containers.

Alternative packages that are recyclable biodegradable and/or compostable are in demand. One such package includes cellulose-based substrates, sourced from renewal materials that can be recycled and/or compostable. The package is made by joining two cellulosic substrates with an air gap interposed in between the two. Some drawbacks to these alternative packages include low insulation and poor structural integrity over the plastic packages. As the package is handled and flexed, the air gap between the two substrates become compressed and the insulation is decreased in those compressed areas. Insulation can be improved by increasing the air gap between the cellulose substrate layers, increasing the thickness of the cellulose substrates or inserting a cellulose medium in between the two layers.

Some of the abovementioned improved packages are described in U.S. Pat. Nos. 9,580,629 B2, 8,747,603 B2, 9,273,230 B2, 9,657,200 B2, US 20140087109 A1, US 20170130399 A1, US 20170130058 A1, and US 20160263876 A1. The packages are formed with an air gap in the coating/adhesive/foamable compositions sandwiched between two substrates, which provides insulation. However, these packages may result in non-uniform insulation if substrate's thickness is over 1.5 inches. WO 2019/018523 A1 disclosed an improved foaming method by exposing the foamable composition to a dielectric heating to achieve uniform insulation for different size of packages. All the aforementioned coating/adhesive/foamable compositions are water-based or emulsion-based, although they empowered improved insulative properties to the packages, the water-based or emulsion-based composition has limited shelf life and not convenient for shipping, especially in summertime when temperature is higher than 35° C., because the liquid-based composition may become bubbly and ultimately resulting in phase separation in high temperature. In addition, the shipment cost can be reduced due to the lower weight and volume of the compositions compared to conventional products.

There is a need in the art for a foamable composition and foaming method that is able to withstand prolonged storage and shipment in high temperature while achieving improved foamable property so as to offer insulation in the manufacture of an article.

### SUMMARY OF THE INVENTION

One embodiment disclosed herein is a foamable powder-based composition, comprising:
(a) at least one powder-based polymer in an amount of no less than 8% by weight, based on the total weight of the composition,
(b) at least one plurality of expandable microspheres in an amount of no less than 15% by weight, based on the total weight of the composition, and
(c) optionally at least one filler,
wherein the plurality of expandable microspheres in the composition expands when heating; and
wherein the composition has a water content of no more than 3% by weight based on the total weight of the composition.

Another embodiment is directed to a foaming method, comprising the steps of:
(i) forming a powder mixture of (a) one powder-based polymer in an amount of no less than 8% by weight, based on the total weight of the powder mixture, (b) one plurality of expandable microspheres in an amount of no less than 15% by weight, based on the total weight of the powder mixture, (c) optionally one filler, and (d) optionally, an additive, wherein the powder mixture has a water content of no more than 3% by weight based on the total weight of the powder mixture;
(ii) adding water into the powder mixture obtained from step (i) and mix to form a composition dispersion, wherein the composition dispersion has a solid content of larger than 58%; and
(iii) exposing the composition dispersion to conventional or dielectric heating or a combination thereof.

Yet another embodiment is directed to a process for forming an article comprising the steps of:
A process for forming an article comprising the steps of:
(i) forming a powder mixture of (a) one powder-based polymer in an amount of no less than 8% by weight, based on the total weight of the powder mixture, (b) one plurality of expandable microspheres in an amount of no less than 15% by weight, based on the total weight of the powder mixture, (c) optionally one filler, and (d) optionally, an additive, wherein the powder mixture has a water content of no more than 3% by weight based on the total weight of the powder mixture;
(ii) adding water into the powder mixture obtained from step (i) and mix to form a composition dispersion, wherein the composition dispersion has a solid content of larger than 58%;
(iii) applying the composition dispersion onto a first substrate;
(iv) applying a second substrate onto the composition dispersion, thereby forming the article wherein the composition dispersion is sandwiched between the two substrates; and
(v) applying to the article by a conventional or dielectric heating or a combination thereof.

Other features and aspects of the subject matter are set forth in greater detail below.

### BRIEF DESCRIPTION OF THE FIGURES

FIG. 1 shows a photograph of the composition of Example 1 activated by microwave heating immediately after expansion of the microspheres.

FIG. 2 shows a photograph of the composition of Example 3 activated by microwave heating immediately after expansion of the microspheres.

FIG. 3 shows a photograph of the composition of Comparative Example 1 activated by microwave heating immediately after expansion of the microspheres.

FIG. 4 shows a photograph of the composition of Comparative Example 2 activated by microwave heating immediately after expansion of the microspheres.

FIG. 5 shows a photograph of the composition of Comparative Example 3 activated by microwave heating immediately after expansion of the microspheres.

FIG. 6 shows a photograph of the composition of Comparative Example 4 activated by microwave heating immediately after expansion of the microspheres.

### DETAILED DESCRIPTION

It is to be understood by one of ordinary skill in the art that the present discussion is a description of exemplary embodiments only, and is not intended as limiting the broader aspects of the present invention.

Unless specified otherwise, in the context of the present invention, the terms used are to be construed in accordance with the following definitions.

Unless specified otherwise, as used herein, the terms “a”, “an” and “the” include both singular and plural referents.

The terms “comprising” and “comprises” as used herein are synonymous with “including”, “includes” or “containing”, “contains”, and are inclusive or open-ended and do not exclude additional, non-recited members, elements or process steps.

The term “at least one” or “one or more” used herein to define a component refers to the type of the component, and not to the absolute number of molecules.

Unless specified otherwise, “about” as used herein in connection with a numerical value refers to the numerical value±10% of the value, preferably±5% of the value. For example, “about 20% by weight” thus relates to 20±2% by weight, preferably 20±1% by weight.

Unless specified otherwise, the recitation of numerical end points includes all numbers and fractions subsumed within the respective ranges, as well as the recited end points.

Unless otherwise defined, all terms used in the present invention, including technical and scientific terms, have the meaning as commonly understood by one of the ordinary skilled in the art to which this invention belongs.

According to the first aspect of the present invention, the present invention provides a foamable powder-based composition, comprising:
(a) at least one powder-based polymer in an amount of no less than 8% by weight, based on the total weight of the composition,
(b) at least one plurality of expandable microspheres in an amount of no less than 15% by weight, based on the total weight of the composition, and
(c) optionally at least one filler,
wherein the plurality of expandable microspheres in the composition expands when heating, wherein the composition has a water content of no more than 3% by weight based on the total weight of the composition.

### (a) Powder-Based Polymer

According to the present invention, the foamable powder-based composition comprises no less than 8% by weight of at least one powder-based polymer, based on the total weight of the composition.

The powder-based polymer may include any desired polymer components, including vinyl acetate homopolymers, copolymers produced from vinyl acetate and at least one other monomer, copolymers produced from vinyl chloride and at least one other monomer, and mixtures thereof. Particularly preferred powder-based polymers may be copolymers produced from vinyl acetate and at least one other monomer, such as ethylene.

The powder-based polymer used as the component (a) can be prepared by spray-drying polymer dispersions. When the powder-based polymer in contact with water, the dispersible polymer powder grains disintegrate and releases the individual dispersion particles again. The dispersed polymer powder has the same properties as the original dispersion.

Useful powder-based polymers are commercially available under a variety of trade designations including, e.g., VINNAPAS™ 5044 N, 5043 N, 4121 N, 4042 H and 5048 H from Wacker.

With particular preference, the powder-based polymer may be present in an amount of from 10% to 50% by weight, more preferably from 10% to 40% by weight, based on the total weight of the composition.

### (b) Expandable Microspheres

According to the present invention, the foamable powder-based composition comprises no less than 15% by weight of at least one plurality of expandable microspheres, based on the total weight of the composition, wherein the plurality of expandable microspheres in the composition expands when heating.

Useful expandable microspheres used in the present invention can expand in size in the presence of heat. The expandable microspheres useful in the present invention include, for example, heat expandable polymeric microspheres, including those having a hydrocarbon core and a polyacrylonitrile shell (such as those sold under the trade name DUALITE™) and other similar microspheres (such as those sold under the trade name EXPANCEL™). The expandable microspheres may have any unexpanded size, including from about 5 microns to about 30microns in diameter. In the presence of heat, the expandable microspheres of the present invention can increase in diameter by about 3 times to about 10 times the original size. Upon expansion of the microspheres in the composition, the composition becomes a foam-like material, which has improved insulation properties. The microspheres are typically made of plastic or polymeric shells and a blowing agent is inside the shell, designed to activate upon reaching specific temperatures.

The expandable microspheres have a particular temperature at which they begin to expand and a second temperature at which they have reached maximum expansion. Microsphere grades are typically sold with specific expansion (Texp) temperatures and maximum expansion temperatures (Tmax). The initial expansion temperature (Texp) is the typical temperature at which the microspheres start to expand (Texp), and the maximum expansion temperature (Tmax) is the temperature at which the about 80% of the microspheres have expanded. If the microspheres are exposed to temperature far greater than Tmax, the microspheres start to explode and deflate.

One particularly useful microsphere has a Texp of 80° C. to 105° C. The temperature at which the microspheres have reached maximum expansion (Tmax) is desirably from 90° C. to 135° C.

In preferred embodiments, it is desirable that the expandable microspheres may be in a density of less than 10 kg/m³.

Depending on the amount of the microspheres and the type of the polymer, the foamable powder-based composition can have adhesive properties. High levels of microspheres will lead to lower or no adhesive property, whereas low levels, about less than about 30 wt % based on the total weight of the composition, will lead to adhesive property of the composition.

Depending on the fully expanded size of the microspheres, the amount of the expandable microspheres in the composition can be adjusted. Depending upon the particular expandable microspheres used in the composition, the desired amount of the microspheres in the composition may be modified.

The component (b) further increases the structural integrity of the composition after they are expanded. While introducing voids in a matrix typically decreases mechanical integrity, the component (b) in the composition provides stiffness when applied onto substrates. This is particularly useful for packaging fragile contents.

In another embodiment, the component (b) may be pre-expanded. Yet in another embodiment, the microspheres may be a mixture of pre-expanded and expandable microspheres.

It is possible to use commercially available products in the present invention. Examples thereof include Expancel™ 031 WUF 40 available from Nouryon and F-SF 36 available from Matsumoto.

In preferred embodiments, the expandable microspheres may be present in the composition in an amount of from no less than 20% to 70% by weight, more preferably from no less than 20% to 50% by weight, based on the total weight of the composition. The expansion ratio of the expandable microspheres and the loading level of the microspheres will be related to each other.

### (c) Filler

According to the present invention, the foamable composition powder-based may optionally comprise at least one filler.

Exemplary fillers include corn starch, pearl starch, physically modified starch, chemically modified starch, dextrin and mixtures thereof, preferably a mixture of corn starch and dextrin. During foaming, the dextrin is able to provide stickiness to the composition dispersion after water is added.

It is possible to use commercially available products in the present invention. Examples thereof include corn starch available from Cargill, dextrin from Tianzhu Chemical.

With particular preference, the fillers may present in an amount of from 0% to 70% by weight, and more preferably from 10% to 60% by weight, based on the total weight of the composition.

### (d) Additive

The composition optionally further includes (d) at least one additive selected from plasticizer, pigment, dye, stabilizer, anticaking agent, dispersing agent, accelerator that is a multivalent water-soluble salt, and mixtures thereof. These components can be included in an amount of from 0 to 15% by weight based on the total weight of the composition.

Exemplary plasticizers are dibenzoates available as BENZOFLEX™, such as diethylene glycol dibenzoate, dipropylene glycol dibenzoate, and the like.

Exemplary anticaking agents include aluminum, silica, calcium silicate, calcium stearate, magnesium carbonate, magnesium stearate, magnesium, magnesium phosphate, magnesium silicate and mixtures thereof.

The accelerator is a multivalent cation from water-soluble salts, including commonly available sodium chloride, aluminum nitrate, zirconium acetate, ammonium zirconyl carbonate. The addition of the multivalent water-soluble salt shortens the time required for radiation during the expansion of the composition. When added, from 0.05% to 2%, preferably from 0.1 to 1.2% by weight, based on the total weight of the composition, may be used.

Other materials that do not adversely affect the composition and insulating properties of the composition may be used as desired. Other additives and/or salts may be included in the composition to increase the coalescence of the composition, is desired.

In particular preferred embodiments, the foamable powder-based composition, based on the total weight of the composition, comprising:
(a) from 10% to 50% by weight, more preferably from 10% to 40% by weight of at least one powder-based polymer,
(b) from no less than 20% to 70% by weight, more preferably from no less than 20% to 50% by weight of at least one plurality of expandable microspheres,
(c) from 0 to 70% by weight, more preferably from 10% to 60% by weight of at least one filler, and
(d) from 0 to 15% by weight of at least one additive;
   wherein the plurality of expandable microspheres in the composition expands when heating, and wherein the composition has a water content of no more than 3% by weight based on the total weight of the composition. If the composition contains water in a higher amount, the storage stability of the composition will be decreased especially in hot summertime, causing the composition in caking or even phase separation.

According to the present invention, the composition is preferably storage stable under temperature of from 25° C. to 45° C. for at least 2 days, and more preferably is storage stable at 45° C. for at least 7 days. The term “storage stable” means that the composition keeps homogeneous state, and does not show agglomerates or grits under storage.

The composition may be formed as an adhesive or as a coating, herein used interchangeably.

The composition is a powder mixture which is able to withstand prolonged storage and shipment in high temperature. And it is convenient for end user to add water into the powder mixture to form a foamable composition dispersion in prior to use.

### Foaming Method

Another embodiment disclosed herein is a foaming method, comprising the following steps:
(i) forming a powder mixture of (a) one powder-based polymer in an amount of no less than 8% by weight, based on the total weight of the powder mixture, (b) one plurality of expandable microspheres in an amount of no less than 15% by weight, based on the total weight of the powder mixture, (c) optionally one filler, and (d) optionally, an additive, wherein the powder mixture has a water content of no more than 3% by weight based on the total weight of the powder mixture;
(ii) adding water into the powder mixture obtained from step (i) and mix to form a composition dispersion, wherein the composition dispersion has a solid content of larger than 58%; and
(iii) exposing the composition dispersion to conventional or dielectric heating or a combination thereof.

When heating, the plurality of expandable microspheres in the composition dispersion can expand and the composition dispersion can coalesce.

According to the present invention, the composition dispersion obtained in step (ii) has a solid content of larger than 58%, preferably from 60% to 80%, more preferably from 60% to 75%. If solid content is equal to or lower than 58%, the expansion performance of the foamable composition may not be satisfactory.

In preferred embodiments, in step (ii), water can be added in an amount of less than 41% by weight to reach desired solid content of the composition dispersion, based on the total weight of the composition dispersion.

Conventional heating described herein refers to heating in conventional heaters, such as an oven. In some embodiments, the composition of the present invention can be foamed by exposing to convention heating in temperature ranges from 100° C. to 177° C. Heating time is preferably no more than 15 seconds, more preferably no more less than 12 seconds. If heating time is too long, the foamed composition may collapse.

Dielectric heating, electronic heating, radio frequency (RF) heating, and high-frequency heating, all interchangeably used herein, is the process in which high-frequency alternating electric field or radio wave heats a dielectric material. Microwave heating can be included in the dielectric heating described herein.

In some embodiments, the composition of the present invention can be foamed by exposing to microwave in frequencies from over 300 MHz to 300 GHz. Heating time is preferably no more than 15 seconds, more preferably no more less than 12 seconds. If heating time is too long, the foamed composition may collapse.

In other embodiments, the composition of the present invention can be foamed by exposing to RF heating in frequencies from 2 MHz and 300 MHz.

The efficiency of power utilization is far lower in an RF generator than a microwave unit, and thus, microwave unit is the preferred source of heating in the present invention.

In some embodiments, the foaming method may include a combination of dielectric heating and conventional heating applications. For example, expansion of the microspheres may be achieved through dielectric heating, while the removal of excess moisture after expansion may be achieved through direct heat.

### Process for Forming an Article

Another embodiment is directed to a process for forming an article comprising the steps of:
(i) forming a powder mixture of (a) one powder-based polymer in an amount of no less than 8% by weight, based on the total weight of the powder mixture, (b) one plurality of expandable microspheres in an amount of no less than 15% by weight, based on the total weight of the powder mixture, (c) optionally one filler, and (d) optionally, an additive, wherein the powder mixture has a water content of no more than 3% by weight based on the total weight of the powder mixture;
(ii) adding water into the powder mixture obtained from step (i) and mix to form a composition dispersion, wherein the composition dispersion has a solid content of larger than 58%;
(iii) applying the composition dispersion onto a first substrate;
(iv) applying a second substrate onto the composition dispersion, thereby forming the article wherein the composition dispersion is sandwiched between the two substrates; and
(v) applying to the article by a conventional or dielectric heating or a combination thereof.

During heating, once the composition dispersion is expanded and locked in place, the air gap in the foamed microspheres provides insulation and structural integrity to the package. This package is more environmentally sound than traditional extruded polystyrene foam packages.

It is preferable that the water molecules to be efficiently driven off without leaving unsightly wrinkles or unevenness on the substrates. The uniform and evenness of the coalesced coating provides uniform thermal insulation to the article and minimizes unsightly wrinkles on the substrates, while increasing the production.

In preferred embodiments, the first substrate and the second substrate, independently can be selected from a cellulosic substrate, wood or plastic having a melting point greater than 100° C.

Useful cellulosic substrates include fibreboards, chipboards, corrugated boards, corrugated mediums, solid bleached boards (SBB), solid bleached sulphite boards (SBS), solid unbleached boards (SLB), white lined chipboards (WLC), kraft papers, kraft boards, coated papers and binder boards.

The composition dispersion described herein may be useful in multilayer substrates, particularly for cellulosic substrates. Using the composition of the present invention, a greater insulation space may be provided between the two substrates, which it is attached at the point of adhesion. The insulating products useful herein include paper products for consumer use, such as for hot drinking cups and lids, cold drinking cups and lids, hot food containers and lids, cold food containers and lids, freezer cartons and cases, envelopes, bags, and the like.

The composition dispersion may be applied to the first substrate in any configuration desired, including in a series of dots, stripes, waves, checkerboard patterns, any general polyhedron shapes that have substantially flat bases, and combinations thereof. Further, the composition dispersion may be applied to the first surface in a series of cylinders. In addition, if desired, the composition dispersion may be applied to the first surface as a substantially flat sheet, covering the entire first surface (full lamination) or covering a portion of the first surface. A second substrate applied to the top surface of the composition dispersion, forming a sandwiched configuration of: first substrate—composition dispersion with expandable microspheres—second substrate.

Yet in another embodiment, the insulated article comprises a substantially flat substrate and a non-flat, rounded substrate. The composition dispersion is applied either to the substantially flat substrate, the non-flat substrate, or to both substrates, to form the insulated article. The composition dispersion may be applied to completely coat the surface of the substrate(s) or to selectively coat portions of the surface of the substrate(s). The pattern can be random or various ordered designs. The resulting article thus has an insulating space between the liner surfaces. The articles with patterned composition mimic a divider interposed between the two substrates. The space between the two substrates is generated and maintained by the expanded microspheres.

Optionally, a different adhesive may be applied in between the two substrates. This is especially useful to bind the two substrates together if the composition dispersion has low or no adhesive properties. The different adhesive may be applied before, concurrently or after the composition dispersion is applied onto the first substrate. In another embodiment, the different adhesive may be applied on the second substrate, and the two substrates are joined together with the composition dispersion, and the different adhesive sandwiched between the two substrates. Exemplary different adhesive includes hot melt adhesive, pressure sensitive adhesive, waterborne adhesive, and solvent-based adhesives.

According to the process of the present invention, the composition dispersion is applied in between the two substrates to form an article, and then exposed to conventional heating or dielectric heating to coalesce the composition dispersion and to expand the microspheres. The heating therefore locks in the components, including the plurality of expanded microspheres, in place to the surface of the substrates. With the presence of water, the temperature rises to 100° C., and the water is evaporated away while the microspheres expand. The expanded microspheres with a Texp of from 80° C. to 100° C. and Tmax of from 90° C. to 140° C. may expand with the conventional or dielectric heating.

Multilayer substrate packages formed with the composition dispersion containing microspheres improve the ability of the package to withstand strain under a constant stress at elevated and/or reduced temperatures. It is expected to those skilled in the art that the strain of the composition increases with the addition of microspheres at elevated temperature.

According to the present invention, the articles formed by the said process are suitable as protective packages, shipping packages, impact resistant packages, and insulative packages. The packages include cups, food containers, cases, cartons, bags, lids, boxes, envelopes, wraps, clamshells, and the like.

The present invention may be better understood through analysis of the following examples, which are non-limiting and are intended only to help explain the invention.

### Examples

The following examples are intended to assist one skilled in the art to better understand and practice the present invention. The scope of the invention is not limited by the examples but is defined in the appended claims. All parts and percentages are based on weight unless otherwise stated.

### Raw Materials:

AQUENCE EPIX™ 42002 is water-based polymer foamable composition, available from Henkel.

VINNAPAS™ 5044 N is vinyl acetate-ethylene polymeric powder, available from Wacker.

Corn starch is available from Cargill.

Dextrin is available from Tianzhu Chemicals.

Expancel™ 031 WUF 40 is expandable microspheres having Texp of 80° C. and Tmax of 135° C., available from Nouryon.

NaCl is available from Guangdong Guanghua Chemical Factory.

### Test Method:

### Solid Content:

The solid content was determined by drying 1-gram dispersion in a common oven at temperature of 80° C. for 30 minutes and then weighing by a precision scale to calculate the solid content by percentage. The solid content of all composition dispersions was recorded in Tables 2 and 4.

### Expansion Ratio:

All composition samples, in its wet state, were applied on a paper substrate (80 g/m³ brown paper available from Youtai) in a series of dot pattern. Each substrate was activated with microwave heating (700 w, 10 s). The initial height of the coating and the final height after activation were recorded and the expansion ratio was calculated by the equation as follows which were recorded in Tables 2 and 4:

$$Expansion ratio = \frac{\begin{matrix}the final height after activation - \\ the initial height of the coating\end{matrix}}{the initial height of the coating} * 100 \% .$$

Expansion ratio was presented in the form of “X-Y” in the Tables 2 and 4, wherein X was calculated based on the smallest height of the dot, Y was calculated based on the largest height of the dot.

The expansion ratio of AQUENCE EPIX™ 42002 was also tested and calculated using the above method. Its result was defined as Benchmark. The foamable composition dispersions having an expansion ratio no less than Benchmark were considered as acceptable.

### Storage Stability:

Each sample in an amount of 65.5-gram was stored in a jar and kept in a common oven under 45° C. for 7 days. Then 35-gram water was added to each sample to obtain dispersions. The storage stability of each sample was visually observed and defined by the following scales:

| Scale | Description |
|---|---|
| A | Stable dispersion without visible grit |
| B | Dispersion with visible grit |
| C | Phase separation |

A-level was considered as acceptable.

### Preparation for Foamable Compositions:

The foamable compositions were prepared with the following method using components in amounts (parts by weight) listed in the Table 1 as below.

TABLE 1

| | | | | Com. | Com. |
|---|---|---|---|---|---|
| Components (g) | Ex. 1 | Ex. 2 | Ex. 3 | Ex. 1 | Ex. 2 |
| VINNAPAS ™ 5044 N | 25 | 25 | 10 | 5 | 25 |
| Expancel ™ 031 WUF 40 | 20 | 30 | 55 | 20 | 10 |
| Corn starch | 10 | 5 | 0 | 20 | 15 |
| Dextrin | 10 | 5 | 0 | 20 | 15 |
| NaCl | 0.5 | 0.5 | 0.5 | 0.5 | 0.5 |
| Total | 65.5 | 65.5 | 65.5 | 65.5 | 65.5 |

Each foamable composition was made by mixing the components in a vessel.

Preparation for Composition Dispersions and their Expansion Performance:

Five composition dispersions were made by adding 35-gram water into each foamable composition obtained above. In addition, AQUENCE EPIX™ 42002 in a weight of 100.5 grams was prepared separately (marked as Comparative Example 3). The properties of the six composition dispersions were tested using the methods stated above and recorded in Tables 2 and 3 as below.

TABLE 2

| Test result | Ex. 1 | Ex. 2 | Ex. 3 | Com. Ex. 1 | Com. Ex. 2 | Com. Ex.3 |
|---|---|---|---|---|---|---|
| Solid content | 0.66 | 0.66 | 0.66 | 0.66 | 0.66 | 0.54 |
| (%) | | | | | | |
| The initial | 0.284 | 0.285 | 0.269 | 0.277 | 0.279 | 0.282 |
| height of the | | | | | | |
| coating (mm) | | | | | | |
| The final | 0.458-0.560 | 0.520-0.567 | 0.660-0.670 | 0.330-0.510 | 0.301-0.408 | 0.425-0.550 |
| height of | | | | | | |
| coating after | | | | | | |
| activation | | | | | | |
| (mm) | | | | | | |
| Expansion | 61-97 | 82-98 | 145-149 | 19-84 | 8-46 | 51-95 |
| ratio (%) | | | | | | |

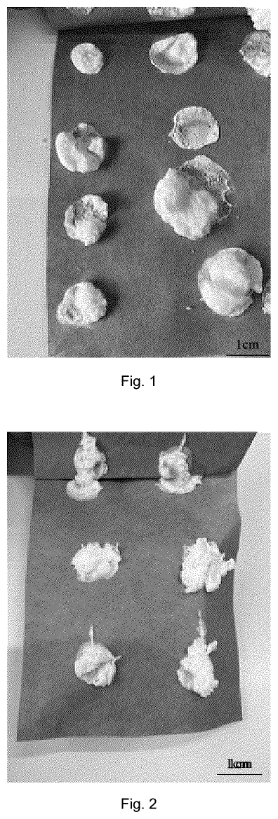

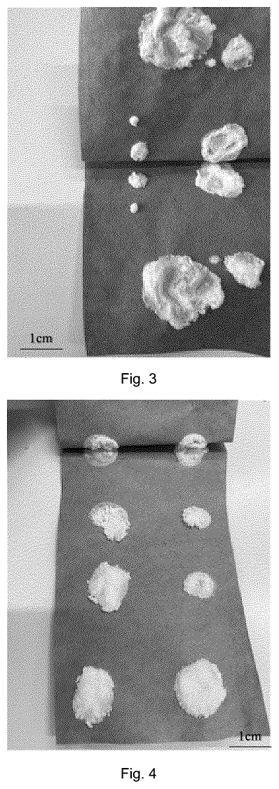

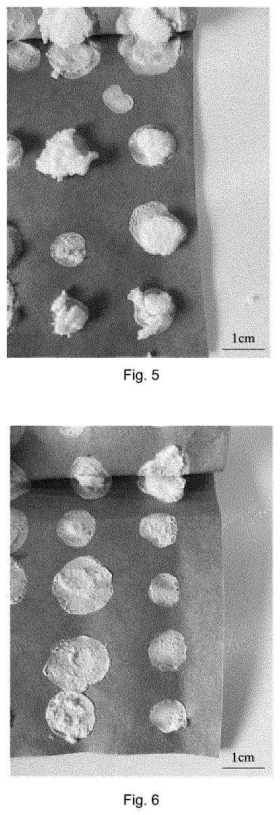

TABLE 3

| Test result | Ex. 1 | Ex. 3 | Com. Ex. 1 | Com. Ex. 2 | Com. Ex.3 |
|---|---|---|---|---|---|
| Expansion | FIG. 1 | FIG. 2 | FIG. 3 | FIG. 4 | FIG. 5 |
| morphology | | | | | |

The expansion ratio of the Examples 1, 2 and 3 of the present invention were apparently larger than the Comparative Example 3. While the compositions having powder-based polymer or expanded microspheres out of the claimed range of the present invention (Comparative Example 1 to 3) did not show satisfactory expansion ratio.

The photographs of the composition dispersions after activation on paper were shown in FIGS. 1 to 5. The Examples of the present invention shown in FIGS. 1 and 2, provided consistent and even expansion, whereas Comparative Examples 1 to 3 (FIGS. 3 to 5) did not provide consistent expansion of the composition.

### The Influence of Solid Contents on Expansion Ratio:

To understand the influence of solids content of composition dispersion on the foamability property, two Example 1 were prepared separately, one was added 35-gram water and the other was added 55-gram water to obtain the composition dispersions having different solid contents, recorded as Example 1 and Comparative Example 4. The properties were tested using the methods stated above and recorded in Table 4 as below.

TABLE 4

| Test result | Ex. 1 | Com. Ex.4 |
|---|---|---|
| Solid content (%) | 0.66 | 0.58 |
| The initial height of the | 0.284 | 0.275 |
| coating (mm) | | |
| The final height of coating | 0.458-0.560 | 0.324-0.456 |
| after activation (mm) | | |
| Expansion ratio (%) | 61-97 | 18-65 |
| Expansion morphology | FIG. 1 | FIG. 6 |

As can be seen from the FIGS. 1 and 6, the composition dispersion having a solid content of larger than 58% provided a consistent and even expansion.

### Storage Stability Test Result:

Four examples having formulations similar to Example 1 were prepared separately but different amount of water was added to form Ex.1a to Ex.1d having a range of water content (wt % based on the weight of the foamable composition) listed in Table 5 as below. The storage stability properties of Ex. 1a to Ex. 1d and Com. Ex. 3 were tested using the methods stated above and recorded in Table 6 as below.

TABLE 5

| Components (g) | Ex. 1a | Ex. 1b | Ex. 1c | Ex. 1d |
|---|---|---|---|---|
| VINNAPAS ™ 5044 N | 25.000 | 24.260 | 23.750 | 23.250 |
| Expancel ™ 031 WUF 40 | 20.000 | 19.400 | 19.000 | 18.600 |
| Corn starch | 10.000 | 9.700 | 9.500 | 9.300 |
| Dextrin | 10.000 | 9.700 | 9.500 | 9.300 |
| NaCl | 0.500 | 0.480 | 0.475 | 0.465 |
| water | 0 | 1.965 | 3.275 | 4.585 |
| Total weight | 65.500 | 65.500 | 65.500 | 65.500 |
| Water content (%) | 0 | 3 | 5 | 7 |

TABLE 6

| Test result | Ex. 1a | Ex. 1b | Ex. 1c | Ex. 1d | Com. Ex. 3 |
|---|---|---|---|---|---|
| Storage stability Level | A | A | B | B | C |

Compositions of the present invention having water content (wt % based on the weight of the foamable composition) of no more than 3 wt % has satisfactory storage stability.

Although some preferred embodiments have been described, many modifications and variations may be made thereto in light of the above teachings. It is therefore to be understood that the invention may be practiced otherwise than as specifically described without departing from the scope of the appended claims.

1. A foamable powder-based composition, comprising:
(a) at least one powder-based polymer in an amount of no less than 8% by weight, based on the total weight of the composition,
(b) at least one plurality of expandable microspheres in an amount of no less than 15% by weight, based on the total weight of the composition, and
(c) optionally at least one filler, selected from corn starch, pearl starch, physically modified starch, chemically modified starch, dextrin, and mixtures thereof,
wherein the plurality of expandable microspheres in the composition expands when heating; and
wherein the composition has a water content of no more than 3% by weight of the total weight of the composition.

2. The foamable powder-based composition according to claim 1, wherein the powder-based polymer is selected from vinyl acetate homopolymers, copolymers produced from vinyl acetate and at least one other monomer, copolymers produced from vinyl chloride and at least one other monomer, and mixtures thereof.

3. The foamable powder-based composition according to claim 1, wherein the expandable microspheres have a hydrocarbon core and a polyacrylonitrile shell.

4. The foamable powder-based composition according to claim 1, wherein the expandable microspheres have an initial expandable temperature range of from 80° C. to 110° C., and a maximum expandable temperature range of from 50° C. to 150° C.

5. (canceled)

6. The foamable powder-based composition according to claim 1, wherein the composition further comprises (d) at least one additive selected from plasticizer, pigment, dye, stabilizer, anticaking agent, dispersing agent, accelerator that is a multivalent water-soluble salt, and mixtures thereof.

7. The foamable powder-based composition according to claim 6, wherein the accelerator is selected from sodium chloride, aluminum nitrate, zirconium acetate, ammonium zirconyl carbonate, and mixtures thereof.

8. The foamable powder-based composition according to claim 1, wherein the powder-based polymer is present in an amount of from 10% to 40% by weight, based on the total weight of the composition.

9. The foamable powder-based composition according to claim 1, wherein the expandable microspheres are present in an amount of from no less than 20% to 50% by weight, based on the total weight of the composition.

10. The foamable powder-based composition according to claim 1, wherein the filler is present in an amount of from 10% to 60% by weight, based on the total weight of the composition.

11. The foamable powder-based composition according to claim 1, wherein the composition is storage stable at 45° C. for at least 7 days.

12. A foaming method, comprising the steps of:
(i) forming a powder mixture of (a) one powder-based polymer in an amount of no less than 8% by weight, based on the total weight of the powder mixture, (b) one plurality of expandable microspheres in an amount of no less than 15% by weight, based on the total weight of the powder mixture, (c) optionally one filler, selected from corn starch, pearl starch, physically modified starch, chemically modified starch, dextrin, and mixtures thereof, and (d) optionally, an additive, wherein the powder mixture has a water content of no more than 3% by weight based on the total weight of the powder mixture;
(ii) adding water into the powder mixture obtained from step (i) and mix to form a composition dispersion, wherein the composition dispersion has a solid content of larger than 58%; and
(iii) exposing the composition dispersion to conventional or dielectric heating or a combination thereof.

13. A process for forming an article comprising the steps of:
(i) forming a powder mixture of (a) one powder-based polymer in an amount of no less than 8% by weight, based on the total weight of the powder mixture, (b) one plurality of expandable microspheres in an amount of no less than 15% by weight, based on the total weight of the powder mixture, (c) optionally one filler, and (d) optionally, an additive, wherein the powder mixture has a water content of no more than 3% by weight based on the total weight of the powder mixture;
(ii) adding water into the powder mixture obtained from step (i) and mix to form a composition dispersion, wherein the composition dispersion has a solid content of larger than 58%;
(iii) applying the composition dispersion onto a first substrate;
(iv) applying a second substrate onto the composition dispersion, thereby forming the article wherein the composition dispersion is sandwiched between the two substrates; and
(v) applying to the article by a conventional or dielectric heating or a combination thereof.

14. The process of claim 13, wherein the first substrate and the second substrate, independently are selected from a cellulosic substrate, wood or plastic having a melting point greater than 100° C.

15. The process of claim 13, wherein the cellulosic substrate is a fiberboard, chipboard, corrugated board, corrugated medium, solid bleached board (SBB), solid bleached sulphite board (SBS), solid unbleached board (SLB), white lined chipboard (WLC), kraft paper, kraft board, coated paper or binder board.

16. The process of claim 13, wherein the composition dispersion is applied in a pattern that is a series of dots, stripes, waves, checkerboards, or a polyhedron shape that have substantially a flat base.

17. The process of claim 13, further comprising the steps of applying an adhesive, in between the first substrate and a second substrate, which is a hot melt adhesive.

18. The process of claim 13, wherein the dielectric heating is microwave heating or radio frequency heating or combinations thereof.

19. The process of claim 13, wherein the article is a cup, food container, case, carton, bag, box, lids, envelope, wrap or clamshell.
